(19) United States
(12) Patent Application Publication
(10) Pub. No.: US 2004/0055099 A1
(43) Pub. Date: Mar. 25, 2004

(54) Ergonomic handle system for tool head

(76) Inventor: William A. Greenberg, St. Paul, MN (US)

Correspondence Address: Dale A. Bjorkman, Kagan Binder, PLLC, Maple Island Building, 221 Main Street North, Suite 200, Stillwater, MN, 55082-5021, US

(21) Appl. No.: 10/405,452

(22) Filed: Apr. 1, 2003

Related U.S. Application Data
(63) Continuation-in-part of application No. 10/252,188, filed on Sep. 23, 2002, now abandoned.

(51) Int. Cl. A46B 15/00; B25G 1/00

(52) U.S. Cl. 15/143.1

(57) ABSTRACT

An ergonomic push broom. The push broom includes a broom head and a primary handle. The broom head has a plurality of bristles that extend downwardly from the broom head. The primary handle includes a linearly extending rod having first and second ends. The first end of the linearly extending rod is attached to the broom head such that the linearly extending rod extends upwardly and at an angle away from the broom head with respect to the downwardly extending bristles. The primary handle also includes a downwardly radially curving portion extending from a second end of the linearly extending rod and includes a plurality of grasping locations.

This application is a continuation-in-part of U.S. patent application Ser. No. 10/252,188, filed Sep. 23, 2002, entitled “Handle For a Cleaning Implement,” which application is incorporated herein by reference in its entirety.

### FIELD OF THE INVENTION

The present invention relates generally to long-handled tools such as push brooms, hoes, rakes, and the like, which are of the type generally used by persons in a standing position. More particularly, the present invention relates to an ergonomic handle system for long-handled tools that includes a curved handle portion and an optional auxiliary handle.

### BACKGROUND OF THE INVENTION

Long-handled tools such as push brooms, rakes, hoes, shovels, and the like are well known. These tools are routinely used by farmers, gardeners, and homeowners, as well as other individuals in a standing or upright position. As an example, push brooms are one such long-handled tool in widespread use and are often used to sweep floors, roadways, and the like clean of dirt or debris. A typical push broom basically consists of a brush block having downwardly extending bristles, and a long straight handle attached to the brush block. Most push brooms are constructed so that the handle is angled backwards from the brush block so that the bristles can contact a surface to be swept when a user holds the broom while standing in an upright posture. With this construction, the handle may be grasped and pushed forward or pulled rearward by the user to sweep a surface.

Although these conventionally known long-handled tools work well for some users, many users find these tools uncomfortable and difficult to use efficiently. One reason for this is related to the straight-line structure of the handles for such tools. That is, these handles are primarily long cylindrical tubes or rods of varying cross-section. In order to operatively grasp a handle of this type, most users need to bend over the handle in order to grasp it, commonly, with one hand in front of the other. Many people find this type of grip and posture uncomfortable, especially over long periods of use, and limiting in the range of motion that it provides for using the tool. In particular, this type of grip positions the hands in a generally unnatural arrangement. Moreover, such a bent over stance can further limit the efficient use of the tool and reduce comfort.

### SUMMARY OF THE INVENTION

The present invention overcomes the disadvantages and shortcomings of the prior art by providing ergonomic handles that can be attached to a plurality of tool heads to form various long-handled tools. The principles of the present invention are particularly advantageous when applied to long-handled tools that are used in a standing or upright posture, such as push brooms or the like, for example. The handles of the present invention advantageously acknowledge the natural angles between the gripping portion of the hand, the axis of the forearm, and their alignment with the torso, during use. This tool handle configuration provides an advantageous ergonomic anatomical posture, emphasizing a relatively straight, balanced, and relaxed alignment of the wrists, arms and torso. Moreover, this tool handle configuration allows a user to operate the tool in a natural upright stance without having to bend over. As such, this posture improves the likelihood of tool control and comfort during work performance. The handle of the present invention, therefore, allows the user to perform work activities more comfortably and for a longer period of time than conventional prior art handles.

In one embodiment of the present invention, an ergonomic push broom is provided that can be used in a working orientation of the broom. The push broom includes a broom head and a primary handle. The broom head has a plurality of bristles that extend downwardly from the broom head. The primary handle includes a linearly extending rod having first and second ends. The first end of the linearly extending rod is attached to the broom head such that the linearly extending rod extends upwardly and at an angle away from the broom head with respect to the downwardly extending bristles. The primary handle also includes a downwardly radially curving portion extending from a second end of the linearly extending rod and having a plurality of grasping locations.

In another embodiment the push broom of the present invention includes a secondary handle. The secondary handle includes a graspable portion outwardly extending from the linearly extending rod of the primary handle and may be positioned between the first and second ends of the linearly extending rod. In certain aspects of the present invention, the secondary handle may be adjustably positionable along the linearly extending rod of the primary handle. Also, the secondary handle may be angularly and rotationally adjustable with respect to the linearly extending rod of the primary handle.

In another embodiment, the present invention provides a handle kit that can be used to convert an existing long-handled tool to an ergonomic long-handled tool in accordance with the present invention. Such a long-handled tool generally includes a handle comprising a linearly extending rod having an end. The kit of the present invention includes a supplemental handle that can be attached to an end of a long-handled tool. The supplemental handle includes an engagement portion for engaging with the end of the linearly extending rod of a long-handled tool. In one aspect of the present invention, the engagement portion may comprise a sleeve that can receive at least a portion of the linearly extending rod of a long-handled tool for attaching the supplemental handle to the linearly extending rod. The supplemental handle also includes a radially curving portion having a plurality of grasping locations. The kit may also include, in another embodiment, a supplemental auxiliary handle that is attachable to the linearly extending rod of a long-handled tool such that the supplemental auxiliary handle extends from the linearly extending rod.

In another embodiment, the present invention provides an ergonomic handle for use with a tool head to provide an ergonomic long-handled tool. The ergonomic handle comprises a primary handle and a secondary handle. The primary handle includes a linearly extending portion that is engagable with a tool head at a first end of the linearly extending portion. The primary handle also includes a radially curving portion extending from a second end of the linearly extending portion. The radially curving portion has a plurality of grasping locations. The secondary handle includes a graspable portion that extends outwardly from the linearly extending portion of the primary handle and is positioned between the first and second ends of the linearly extending portion.

In another embodiment, the present invention provides a method of using a push broom. The method comprises providing a push broom, grasping a portion of a primary handle of the push broom with a first hand, grasping a portion of a secondary handle with a second hand, and pushing the broom. The push broom comprises a broom head, a primary handle, and a secondary handle. The broom head includes a plurality of bristles extending downwardly from the broom head. The primary handle comprises a linearly extending rod and a downwardly radially curving portion. The linearly extending rod is attached to the broom head at a first end of the linearly extending rod and upwardly angularly extending away from the broom head with respect to the downwardly extending bristles. The downwardly radially curving portion extends from a second end of the linearly extending rod and includes a plurality of grasping locations. The secondary handle includes a graspable portion outwardly extending from the linearly extending rod of the primary handle and is positioned between the first and second ends of the linearly extending.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a perspective view of a prior art push broom shown being used by a user;

FIG. 2 is a side view of an exemplary handle of the present invention shown attached to a tool head and showing a primary handle having a curved portion and an auxiliary handle;

FIG. 3 is a front view of the handle and tool head of FIG. 2;

FIG. 4 is a perspective view of an auxiliary handle that can be used in accordance with the present invention;

FIG. 5 is a perspective view of a clamp that can be used to adjustably attach the auxiliary handle of FIG. 4 to a handle in accordance with the present invention;

FIG. 6 is a side view of a bracket that can be used to attached a tool head to a handle of the present invention;

FIG. 7 is a perspective view of another exemplary handle of the present invention;

FIG. 8 is a perspective view of a push broom of the present invention shown being used by a user;

FIG. 9 is a top view of the orientation of the hands of the user of FIG. 8;

FIG. 10 is a top view of an alternate orientation for the hands of the user of FIG. 8.

### DETAILED DESCRIPTION

The present invention provides ergonomic tool handles that can be engaged with various tool heads to provide long-handled tools. Generally, the principles of the present invention are particularly advantageous when applied to long-handled tools that are used in a standing or upright position and that employ a push and/or pull type of motion. One such group of long-handled tools that can benefit from the principles of the present invention includes various push brooms. Other long-handled tools that can benefit from the principles of the present invention include mops, rakes, hoes, scrapers, squeegees, and the like.

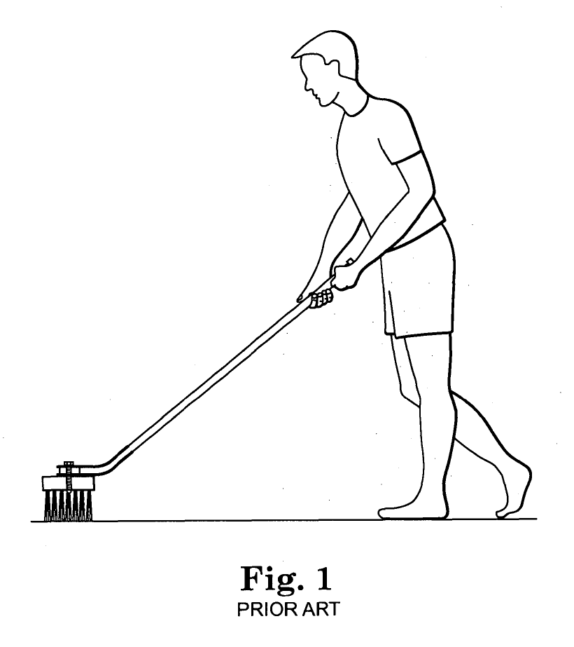

Conventional handles for such long-handled tools are typically-elongated rods of varying cross-section. Because of this elongated rod structure of known handles, a user must bend over the handle and hold the handle in a somewhat unnatural manner, that is, with one hand in front of the other, as is illustrated in FIG. 1. This posture and grip can be uncomfortable for many users. Moreover, such a grip may be inefficient because power is translated to a push and/or pull stroke of the broom through frictional resistance between the users hands and the handle. That is, a user needs to squeeze the handle in order to prevent the handle from slipping in the users hands during a power stroke. This can lead to fatigue and often can cause blisters to form, especially after long-term use.

Accordingly, the present invention provides advantageous tool handles that can be used with long-handled tools, particularly those used in an upright or standing position. Tool handles of the present invention generally include a primary handle that includes an elongated linearly extending section or portion, attachable to a tool head at one end, and a generally downwardly curving portion extending from another end. Advantageously, the downwardly curving portion can be grasped in a variety of locations along the curve to accommodate many users having different physical features such as arm length, height, etc. Moreover, the downwardly curving portion can provide alternate grips for any one single user. Such alternate grips can help reduce fatigue and can allow a user to adjust the grip for varying tasks such as for sweeping under a table or other structure, for example.

Tool handles of the present invention may also optionally include an outwardly extending auxiliary handle that can be adjustably positioned relative to the linearly extending section of the primary handle as well as the downwardly curving portion. As such, the downwardly curving portion and the outwardly extending handle can be arranged with respect to each other in a variety of ways so the hands of a user can be positioned in a natural, ergonomic manner. For example, in one embodiment, the downwardly curving portion can be grasped with one hand such that the thumb is in a generally upwardly facing orientation and the outwardly extending handle can be grasped with another hand such that the thumb is in a generally inwardly facing direction. This type of grip can provide a more upright posture and a more natural alignment of the hands, wrists, and forearms thus providing the ability to more efficiently transfer power to a tool head, move a tool head controllably, and work more comfortably, especially for longer periods of time.

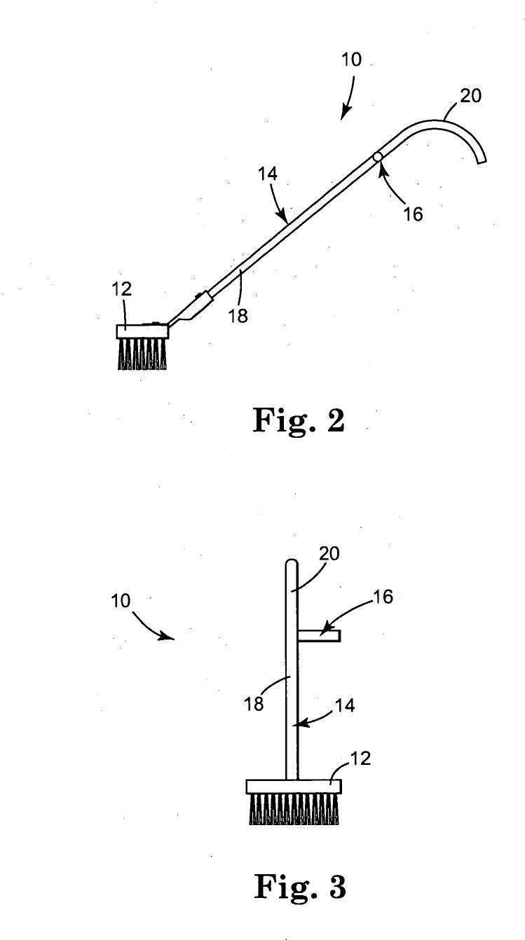

Referring now to FIGS. 2 and 3, one exemplary embodiment of an ergonomic handle 10 of the present invention is shown. As shown, the handle 10 is attached to a push broom head 12 for illustrative purposes and may be attached to any tool head as desired. A preferred method for attaching the handle 10 to a tool head is described in detail below. In FIG. 2 the handle 10 is shown in a side view and in FIG. 3 the handle 10 is shown in a front view.

Generally, as shown, the handle 10 includes a primary handle 14 and an optional auxiliary handle 16. The primary handle 14 preferably includes a linearly extending elongated portion 18 and a downwardly curving portion 20. Preferably, the downwardly curving portion 20 extends from an end of the linearly extending elongated portion 18 and curves away from the linearly extending elongated portion 18 for a length. Also preferably, the downwardly curving portion 20 curves radially, that is, the curve has a generally consistent radius. In other words, the downwardly curving portion 20 preferably forms an arc or a segment of a circle extending from an end of the linearly extending elongated portion 20.

In one embodiment, the linearly extending elongated portion 18 and the downwardly curving portion 20 are formed as a single continuous piece to form the primary handle 14. Alternatively, the primary handle 14-may be formed from any number of pieces that are joined together to form the primary handle 14. For example, the linearly extending elongated portion 18 may be formed as one piece while the downwardly curving portion 20 may be formed as a separate piece. The separate pieces may be operatively joined to form the primary handle 14. For example, any mechanical coupling device or technique such as a threaded or other interlocking connection, press fit, or a welded or fused connection may be used.

Preferably, the primary handle 14 comprises a generally circular cross-section. The primary handle 14 may, however, comprise any cross-section such as square, octagonal, etc., either for the entire primary handle 14 or for any desired portions thereof. For example, the entire primary handle 14 may be formed from a rod or tube or the like. As another example, the linearly extending elongated portion 18 may be formed from a tube having a generally circular cross-section while the downwardly curving portion 20 may be formed to have an elliptical or oval cross-section. That is, the downwardly curving portion 20 may be formed to have a cross-section or shape that corresponds with a closed or gripping hand.

The primary handle 14 may be formed from any material such as metal, plastic, wood, etc. depending on such factors as the desired strength and weight of the primary handle 14, for example. Other factors may include any requirements of the desired environment of use of the primary handle 14, such as those related to moisture resistance, electrical insulation, and corrosion resistance, for example. Also, the primary handle 14 may include coatings or coverings such as for providing a more comfortable grip. For example, portions of the primary handle 14 may include foam coverings or the like for providing a softer gripping surface. As mentioned above, the primary handle 14 may be formed from any number of sections and each section may be formed from the same or different materials, as desired. One exemplary preferred material for the primary handle 14 is aluminum tube having a diameter of about 1 inch and a wall thickness of about 0.05 inches. Depending on material, the primary handle 14 may be formed by any fabrication technique, known or developed, such as injection molding, stamping, pressing, conventional metalworking, and the like.

Preferably, the primary handle 14 is formed to accommodate a variety of users having different physical parameters such as arm length and height and the like. One such preferred primary handle 14 that can be used with a tool head such as the push broom head 12 comprises a linearly extending elongated portion 18, such as a rod or the like, having a length of between about 40 and 60 inches and a downwardly curving portion 20 that has a radius of curvature of between about 5 and 8 inches, which curves downwardly through an angle of between about 90 and 120 degrees.

It is noted that the linearly extending elongated portion 18 may have any length to accommodate any desired tool head and may also be adjustable in length if desired. For example, the linearly extending elongated portion 18 may be adjustable in length by using a telescoping structure or the like. Moreover, the downwardly curving portion 20 may follow any desired downward curve, preferably generally radial or arcuate, and may have any desired radius of curvature. As one example, the downwardly curving portion 20 may curve or loop back to the linearly extending elongated portion 18 to form a closed loop, if desired.

Preferably, the auxiliary handle 16 extends outwardly for a length from the primary handle 14 (see FIG. 3). The auxiliary handle 16 may extend outwardly from the primary handle 14 for any desired length depending on the tool head to be used and may have any desired cross-section shape and size. As shown in FIG. 3, the auxiliary handle 16 is generally perpendicularly oriented to the linearly extending elongated portion 18 of the primary handle 14. Also, as shown, the auxiliary handle 16 is perpendicularly oriented with respect to a plane containing the downwardly curving portion 20. The auxiliary handle 16 may, however, be oriented at any desired angle with respect to the linearly extending elongated portion 18 of the primary handle 14 so as to allow a hand of a user to be positioned in any desired manner. Optionally, the angle of the auxiliary handle may be adjustable with respect to the primary handle 14. The auxiliary handle 16 may be formed as a separate handle or alternatively may be formed as an integral part of the primary handle 14. For example, the primary handle 14 and the auxiliary handle 16 may be formed as a single structure such as by injection molding or the like. Also, the auxiliary handle 16 may have any desired structure such that it can be grasped by a hand by a user and used to assist in operation of the tool head. It is noted that the auxiliary handle 16 may be straight, pole shaped, curved, open ended, closed ended, triangularly shaped, etc.

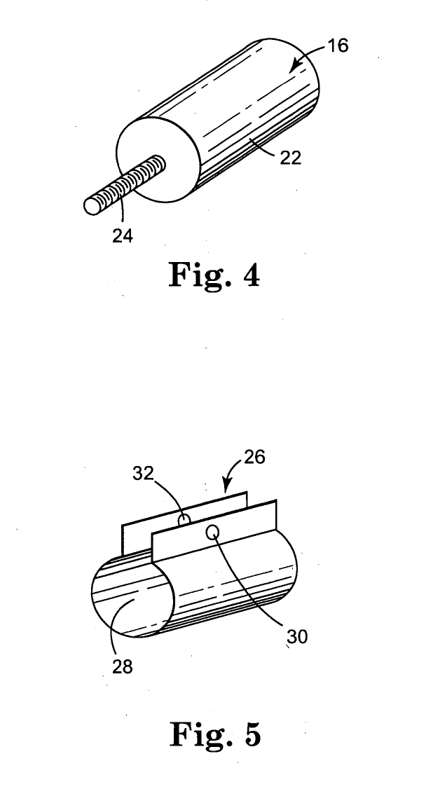

Illustrated in FIG. 4 is one exemplary preferred auxiliary handle 16 and as shown comprises a graspable portion 22 and a threaded portion 24. One exemplary preferred auxiliary handle 16, that may be used with a tool head such as a push broom head, is cylindrical in shape and has a diameter of between about 1 inch and about 4 inches and is between about 3 inches and about 10 inches in length.

Preferably, the auxiliary handle 16 is adjustably positionable, such as linearly, angularly, and/or rotationally, with respect to the primary handle 14. As an example, the bracket 26, shown in FIG. 5, may be used to adjustably attach the auxiliary handle 16 to the primary handle 14 in accordance with the present invention. As shown, the bracket 26 includes an opening 28 that can receive the primary handle 14, such as the linearly extending elongated portion 18. Also as shown, the bracket 26 includes an opening 30, that the threaded portion 24 can pass though, and a tapped portion 32, that the threaded portion 24 can engage with. As such, the auxiliary handle 16 may be attached to the bracket 26 and clamped in place (by rotating the auxiliary handle) at any desired location and orientation with respect to the primary handle 14, especially the downwardly curving portion 20. Advantageously, the auxiliary handle 16 can be easily adjusted by a user by rotating the auxiliary handle 16 to loosen it and reposition it where desired. It is noted that the auxiliary handle 16 may be attached to the primary handle adjustably or non-adjustably by using any desired technique or mechanical device.

In one embodiment, the auxiliary handle 16 is preferably positioned (permanently or adjustably) within about 30 inches and more preferably within about 20 inches from the end of the primary handle from which the downwardly curving portion extends. When positioned within this range, the auxiliary handle can provide a comfortable hand, wrist, and arm position for a variety of different users. It is contemplated however, that the auxiliary handle 16 may be positioned at any distance from the end of the primary handle.

As mentioned above, the tool handle 10 is preferably attachable to a tool head such as the push broom head 12. The tool handle 10 may be attached to a tool head by any desired technique, such as by using mechanical coupling devices including pivots, brackets, hinges, and combinations thereof, and the like. In any case, it is preferred that the tool handle 10 be attached to a tool head such that the downwardly facing portion 20 of the primary handle 14 is oriented as desired with respect to a particular tool head. For example, for the push broom head 12, the downwardly facing portion 20 of the primary handle 14 is preferably substantially perpendicularly oriented with respect to the push broom head 12, as shown in FIG. 3.

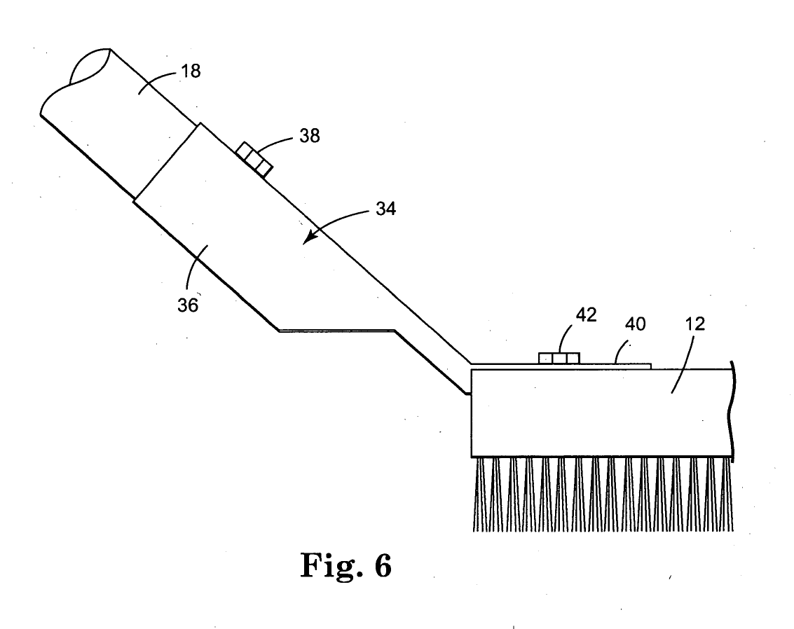

One exemplary bracket 34 that may be used to attach the handle 10 to the push broom head 12 is illustrated in FIG. 6. As shown, the bracket 34 includes a receiver 36 for engaging with an end of the linearly extending elongated portion 18 of the primary handle 14. The elongated portion 18 and the receiver 36 are preferably secured together by using one or more fasteners 38, as shown. The elongated portion 18 and the receiver 36 may, however, be secured together by any means such as by using a friction fit, welded or solder joint, a threaded coupling, or any mechanical device or the like.

The bracket 34 also preferably includes a plate 40 for attaching the bracket 34 to the push broom head 12, such as by using one or more fasteners 42. Preferably, the plate 40 is angularly disposed relative to the receiver 36. As such, the handle 10 can be angularly positioned with respect to the push broom head 12. As an example, the bracket 34 may be formed from sheet metal (or any other desired material). In one preferred embodiment, the bracket 34 may be formed to be used with a tool head such as the push broom head 12. As such, the bracket 34 preferably secures the tool handle 10 at an angle of between about 35 and 55 degrees from the push broom head 12. Preferably, the tool handle 10 is at an angle of about 45 degrees from the floor when in use. Thus, for a tool head such as a push broom head having downwardly extending bristles, the bristles will be generally perpendicular to a working surface, such as a floor or the like, when in use. It is noted, however, that any desired angle may be used for any particular tool head.

In another embodiment of the present invention the downwardly curving portion 20 of the primary handle 14 may be formed as a separate structure that may be attached to an existing handle of a long-handle tool as a supplemental handle. As such, an existing long-handled tool may be converted to an ergonomic long-handled tool in accordance with the present invention. Such a supplemental handle preferable comprises an attachment portion for engaging or attaching the supplemental handle to an end of an existing handle. For example, a supplemental handle in accordance with the present invention may include a sleeve portion that can slide over and engage with an existing handle. The sleeve portion may be used to attach the supplemental handle to an existing handle with a fastener device such as a clamp or the like. The attachment portion of the supplemental handle may comprise any mechanical device or technique or the like for securing the supplemental handle to an existing handle such as a clamp device, threaded device, press fit technique, or the like.

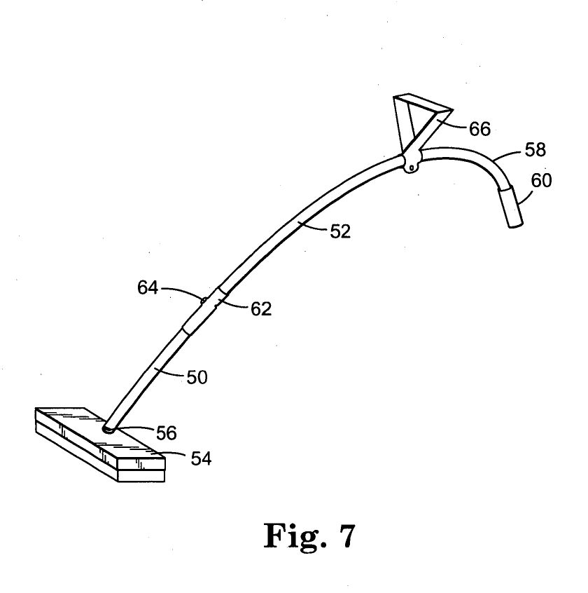

In another embodiment, shown in FIG. 7, the present invention may be characterized as an adjustable handle for a cleaning implement. The handle has a first (lower) section 50 and a second (upper) section 52. Usually sections 50 and 52 are telescoping, but non-telescoping versions could also be made.

In the embodiment shown in FIG. 7, the top section 52 will fit over the bottom section 50, but the handle may also be made so that the top section 52 fits into the bottom section 50. This type of handle can be used for any type of cleaning implement which is operated by using a pushing or pulling motion to clean a floor, lawn, or other surface located at ground level. These cleaning implements include, but are not limited to, mops (especially sponge mops), squeegees, push brooms, and fan rakes.

As shown, the lower section 50 is a generally straight rod or shaft, and is attachable to the head 54 of a cleaning implement. The lower section 50 has threads 56 at the end which fits into the implement head 54 in the version where the implement is a push broom. For mops and squeegees, the lower section 50 would usually be bolted to the implement head. The lower section 50 extends diagonally upward from the head 54.

The upper section 52 is a shaft or rod which is generally straight at its lower end but is curved near its upper end. The curved portion 58 of the upper section 52 is shaped so that the curve extends diagonally upward from the straight part of the upper section 52 to a curved apex, and then diagonally downward to the end of the upper section 52 which is-distal to the cleaning implement 54. The distal end of the upper section 52 of the handle may be covered with a foam handle cover 60. The upper section 52 is adjustably attached to the lower section 50 by means of a sleeve-like rod length adjuster 62 which has a knob 64 disposed through an opening (not shown) in the adjuster 62.

An adjustable handle grip 66 is positioned at the apex of the upper section 52 of the handle. The handle grip 66 will often have a structure similar to shovel handles. In one embodiment, the handle grip 66 is generally rectangular with a generally rectangular central opening through which a user's hand is placed when using the invention. The handle grip 66 attaches to the upper section 52 (at or near the apex thereof) of the handle by means of screws or bolts and wing nuts. The handle grip 66 can be adjusted to the right or to the left.

Alternative embodiments of the handle grip 66 would be a triangular-shaped shovel handle-like structure (as shown in FIG. 7) with a triangular central opening for a user's hand, or a handle grip similar to that used on a weed trimmer, or other conventional handle grips.

To use the invention, a user places his hand into the opening of the handle grip 66 and pushes forward on the handle (sections 52 and 50) to move the cleaning implement along the surface to be cleaned. The user does this while standing upright. If the length of the handle needs to be adjusted, the user adjusts the rod length adjuster 62, and then resumes cleaning.

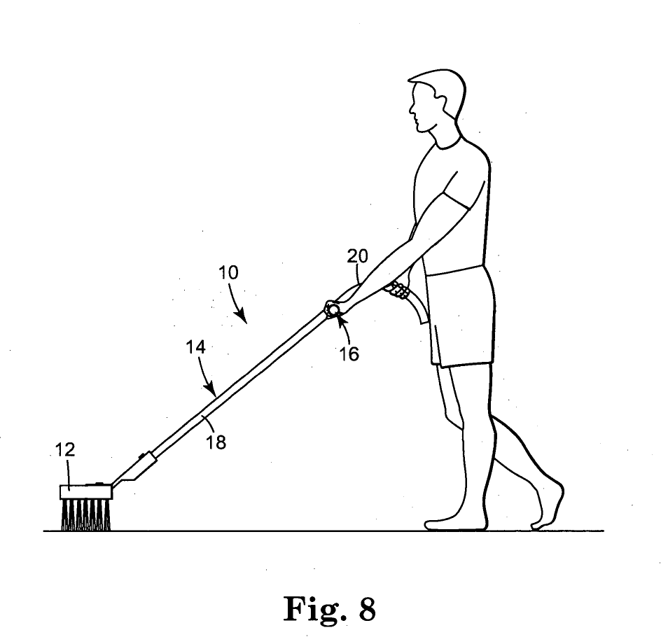

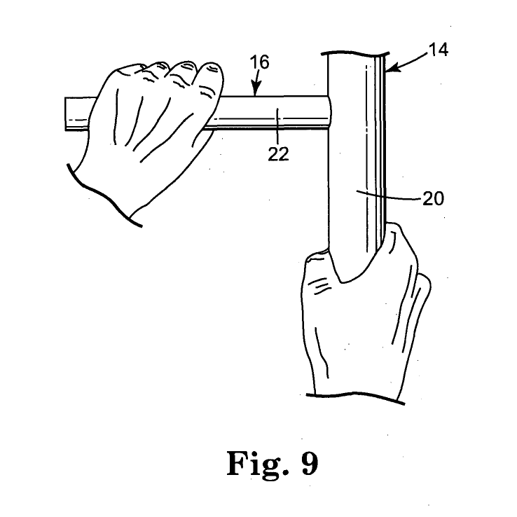

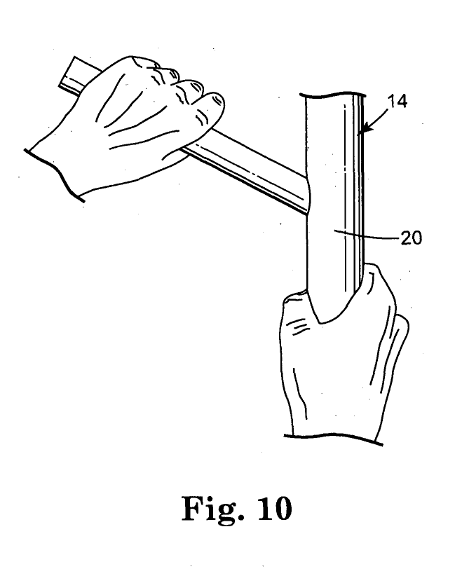

In FIG. 8 a user 70 is shown holding a push broom 72, which includes the handle 10 described above. A top view of the orientation of the first and second hands, 74 and 76, of the user 70 of FIG. 8 is shown in FIG. 9. Also an alternative position for the auxiliary handle 16, that is, angled away form the primary handle 14 and the resulting position of the first and second hands, 74 and 76 is shown in FIG. 10. As shown, a first hand 74, such as a dominant hand, is grasping the downwardly curving portion 20 and a second or opposite hand 76 is grasping the auxiliary handle 16. As shown, the handle 10 of the present invention, advantageously provides a more upright stance for the user 70 and a more ergonomically favorable and balanced alignment of the hands, wrists, and forearms as compared to conventional handles. Pushing force imparted on the push broom is provided with the hands, wrists, and forearms in alignment along the axis of the forearm. As such, minimal lateral forces act on the wrists and more force can be applied in a generally more comfortable manner. Advantageously, the user 70 may grasp the downwardly curving portion 20 in a variety of locations depending on the particular task being performed. Also, the user 70 may grasp the downwardly curving portion 20 in differing locations throughout a work session to minimize fatigue. Moreover, the user 70 may adjust the position of the auxiliary handle 16 as desired especially on ether side or on top. The auxiliary handle 16 also allows for force to be provided in an axial manner thereby providing a natural and comfortable alignment of the hands, wrists, and forearms.

In use, ergonomic tool handles of the present invention allow a user to accomplish the same work as if a conventional linearly extending tool handle had been used, but more efficiently and without the bending and discomfort that can be associated with such tools. In particular, the curved portion of the handle of the present invention provides a user with the capability to grasp the handle in an ergonomically favorable manner, especially when used with the auxiliary handle of the present invention. As a result, the user is able to assume more comfortable and varied generally upright working positions, thus avoiding uncomfortable physical side effects, including back, arm, and leg discomfort. Moreover, the occurrence of hand blisters may be reduced due to the decrease in the amount of pressure needed to be applied to the handle and the consequential reduction in work time. In contrast, conventional tool handles by themselves have practical utility only when the user stands generally behind the tool handle and repeatedly bends at the waist while stretching forward and backward in addition to bearing down on the tool.

Numerous characteristics and advantages of the invention meant to be described by this document have been set forth in the foregoing description. It is to be understood, however, that while particular forms or embodiments of the invention have been illustrated, various modifications, including modifications to shape, size, and arrangement of parts, and the like, can be made without departing from the spirit and scope of the invention.

What is claimed is:

1. An ergonomic push broom having a working orientation, the push broom comprising:
a broom head having a plurality of bristles extending downwardly therefrom; and
a primary handle comprising;
a linearly extending rod operatively attached to the broom head at a first end of the linearly extending rod and upwardly angularly extending away from the broom head with respect to the downwardly extending bristles; and
a downwardly radially curving portion extending from a second end of the linearly extending rod and having a plurality of grasping locations.

2. The push broom of claim 1, further comprising a secondary handle having a graspable portion outwardly extending from the linearly extending rod of the primary handle and positioned between the first and second ends of the linearly extending rod.

3. The push broom of claim 2, wherein the secondary handle is positioned within about 30 inches from the second end of the linearly extending rod.

4. The push broom of claim 2, wherein the secondary handle is adjustably positionable between the first and second ends of the linearly extending rod.

5. The push broom of claim 2, wherein the secondary handle is perpendicularly outwardly extending from the linearly extending rod of the primary handle.

6. The push broom of claim 2, wherein the secondary handle is angularly outwardly extending from the linearly extending rod of the primary handle.

7. The push broom of claim 2, wherein the secondary handle is substantially perpendicular to a plane containing the downwardly radially curving portion.

8. The push broom of claim 2, wherein the secondary handle is integrally formed with the linearly extending rod of the primary handle.

9. The push broom of claim 1, wherein the linearly extending rod has a length of between about 40 inches and about 60 inches.

10. The push broom of claim 1, wherein the linearly extending rod is an adjustable length linearly extending rod.

11. The push broom of claim 1, wherein the linearly extending rod is angularly attached to the broom head an angle of between about 35 degrees and about 45 degrees.

12. The push broom of claim 1, wherein the downwardly radially curving portion curves by a radius of between about 5 inches and about 8 inches.

13. The push broom of claim 12, wherein the downwardly radially curving portion curves through an angle of between about 90 degrees and about 120 degrees.

14. An ergonomic supplemental handle kit for a long-handled tool having a handle comprising a linearly extending rod having an end, the kit comprising:
a supplemental primary handle having an engagement portion for engaging with the end of the linearly extending rod of a long-handled tool and having a radially curving portion having a plurality of grasping locations, and
a supplemental auxiliary handle attachable to the linearly extending rod of a long-handled tool such that the supplemental auxiliary handle extends outwardly from the linearly extending rod.

15. The supplemental handle-kit of claim 14, further comprising an attachment device for attaching the supplemental primary handle to the end of the linearly extending rod of a long-handled tool.

16. The supplemental handle kit of claim 14, wherein the engagement portion comprises a sleeve that can receive at least a portion of the linearly extending rod of a long-handled tool for attaching the supplemental handle to the linearly extending rod.

17. The supplemental handle kit of claim 14 in combination with a push broom.

18. A method of using a push broom, the method comprising:
providing a push broom comprising a broom head having a plurality of bristles extending downwardly therefrom and a primary handle, the primary handle comprising a linearly extending rod operatively attached to the broom head at a first end of the linearly extending rod and upwardly angularly extending away from the broom head with respect to the downwardly extending bristles and a downwardly radially curving portion extending from a second end of the linearly extending rod and having a plurality of grasping locations and a secondary handle having a graspable portion outwardly extending from the linearly extending rod of the primary handle and positioned between the first and second ends of the linearly extending rod;
grasping at least a portion of the radially curving portion with a first hand of a user;
grasping at least a portion of the graspable portion of the secondary handle with a second hand of the user; and
pushing the push broom.

19. An ergonomic handle for use with a tool head to provide an ergonomic long-handled tool, the ergonomic handle comprising:
a primary handle comprising a linearly extending portion engagable with a tool head at a first end of the linearly extending portion and a radially curving portion extending from a second end of the linearly extending portion, the radially curving portion having a plurality of grasping locations; and
a secondary handle having a graspable portion outwardly extending from the linearly extending portion of the primary handle and positioned between the first end of the linearly extending portion and the second end of the linearly extending portion.

20. The ergonomic handle of claim 19 in combination with a tool head.
